(19) United States
(12) Patent Application Publication
(10) Pub. No.: US 2011/0107310 A1
(43) Pub. Date: May 5, 2011

(54) Debugging Device

(75) Inventors: Michael Joseph Pont, Leicestershire (GB); Keith Athaide, Geo (IN); Devaraj Ayavoo, Kedah (MY)

(73) Assignee: University of Leicester

(21) Appl. No.: 12/599,798

(22) PCT Filed: May 9, 2008
(86) PCT No.: PCT/GB2008/001613

§ 371 Date: Jan. 20, 2011

(30) Foreign Application Priority Data
May 11, 2007 (GB) 0709105.1

(51) Int. Cl. G06F 11/36; G06F 9/44

(52) U.S. Cl. 717/129

(57) ABSTRACT

A debugging tool for a time-triggered system comprises means for interrogating the system code to determine task details; means for modifying the system code to include breakpoints, the position of the breakpoints being determined by the task details; means for executing the modified system code; means for measuring the time between pre-determined ones of said breakpoints; and means for reporting the timing results to a user.

### FIELD OF THE INVENTION

This invention relates to a debugging tool. Particularly, but not exclusively, the invention relates to a debugging tool that is suitable for use in the development of time-triggered embedded systems.

### BACKGROUND TO THE INVENTION

Embedded processors are ubiquitous: they form a core component of a vast range of everyday items (cars, aircraft, medical equipment, factory systems, mobile phones, DVD players, music players, microwave ovens, toys etc). In some cases several embedded processors may be employed, each for a specific function. For example, a typical modern car may contain around fifty embedded processors.

In applications where predicable behaviour is an important consideration—such as in automotive systems, aerospace systems, medical systems, industrial systems, and in many brown and white goods—it is vital that a reliable system is used and that it operates in a highly predictable manner. This is important for safety considerations but also because a reliable device is likely to incur reduced maintenance and/or repair costs (and resulting inconvenience to the user) during its operational life. Thus, it is important that such systems are sufficiently robust and that their operation has been fully tested.

A time-triggered (TT) embedded system is a real-time system that executes a set of periodic tasks. Various forms of TT architecture have been described from the simplest form of ‘cyclic executive’, which involves co-operative task scheduling, through to rate-monotonic architectures, which employ pre-emption.

Embedded systems that employ TT scheduling can have highly predicable patterns of behaviour, including low levels of task jitter. When coupled with the fact that TT implementations can have very low resource requirements, this architecture is an appropriate choice for cost-sensitive or safety-related applications, such as automotive control.

However, in any TT design, system behaviour may become unpredictable in situations where one or more tasks either (i) exceed their predicted ‘worst case execution time’ (WCET), or (ii) demonstrate significant levels of task jitter.

In many systems, jitter problems are exacerbated by problems with WCET estimates. This is compounded by the fact that predicting WCET is notoriously difficult.

In addition, traditional debugging tools are not designed for debugging time-triggered systems. Consequently, it is difficult at present to develop predictable TT systems.

It is therefore an object of the present invention to provide a solution that ameliorates some or all of the aforementioned problems.

### SUMMARY OF THE INVENTION

According to a first aspect of the present invention there is provided a debugging tool for a time-triggered system comprising:
means for interrogating the system code to determine task details;
means for modifying the system code to include breakpoints, the position of the breakpoints being determined by the task details;
means for executing the modified system code;
means for measuring the time between pre-determined ones of said breakpoints; and
means for reporting the timing results to a user.

According to a second aspect of the present invention there is provided a method of debugging a time-triggered scheduler comprising the following steps:
interrogating the system code to determine task details;
modifying the system code to include breakpoints, the position of the breakpoints being determined by the task details;
executing the modified system code;
measuring the time between pre-determined ones of said breakpoints; and reporting the timing results to a user.

It will be understood that a breakpoint is an intentional pause of a processor at a specific point in its operation. In a traditional general-purpose processor, (standard) breakpoints may only pause the central processing unit (i.e. by stopping the CPU clock). Such breakpoints may not stop all peripherals. To make accurate timing measurements from such processors, there is therefore a need to manually stop the peripherals (i.e. by stopping each of their respective clocks).

In preferred embodiments of the present invention, the breakpoints are configured to cause both the CPU and peripherals to pause. This may be achieved by the breakpoint triggering a signal to be sent to the CPU and all peripherals to instruct them to pause their respective clocks. Such breakpoints may be specifically referred to hereinafter as “enhanced breakpoints”.

The breakpoints may be software or hardware breakpoints.

The timing results may be taken into account by a system developer to make design improvements/changes to the system. Alternatively, when used in an operational system the timing results can provide an indication of system faults to enable appropriate action to be taken, such as shutting down the system entirely or initiating a system-recovery procedure.

An advantage of the present invention is that time intervals between pre-determined events can be measured simply and accurately, with minimal interference to the normal operation of the system. In addition, due to the device analysing and modifying the system code, the time involved in debugging a system can be greatly reduced along with the risk of human errors. Furthermore, the present invention can be used to perform repeatable measurements with reliable results.

The debugging tool of the present invention may be configured for use in debugging traditional general-purpose processors running time-triggered software, or dedicated time-triggered processors. The tool may also be configured for use with a system-on-chip or a system simulator.

In the case where the tool is used with a dedicated time-triggered processor, the processor may be configured such that when a breakpoint is encountered, a system co-processor is triggered to signal external debug circuitry to broadcast a pause request to the instruction processing unit (IPU) and to all peripherals. This request may cause the IPU and peripherals to stop all processing by de-asserting the clock enables in their respective flip-flop circuitry.

The means for measuring the time between pre-determined breakpoints may comprise a mechanism for using a timer provided for the scheduler. In this case, the timer may overrun if, say, the task period is long. Accordingly, the means for measuring the time between pre-determined breakpoints may comprise a separate ‘debug’ timer with a pre-determined overrun time to permit the intended measurement periods.

In either of the above cases, the value of the timer employed is noted when a first breakpoint is encountered, then the timer is resumed and its value noted again when a subsequent breakpoint is encountered, thereby to measure or calculate the elapsed time.

The task details may comprise the task name or identifier, the location of each task in memory and the number of tasks.

Breakpoints may be inserted at the start of a task and the end of the task so as to enable measurement of the task execution time.

A breakpoint may be inserted at the start of a periodic task so as to enable measurement of the interval between successive start times. The variation between successive start times is known as jitter. Ideally, it is desirable that the jitter in a system is zero.

The debugging tool of the present invention may be configured as a program capable of being run on existing hardware platforms or may be provided in a separate hardware module.

It will be understood that the present invention effectively changes the scheduler code that is run on the system (by including breakpoints) and then makes measurements while the amended software is run to assess the performance of the scheduler in operation.

Although the present invention may be particularly advantageous for use in the development of time-triggered systems and scheduler programs, it may also be a useful diagnostic tool when incorporated into real systems since it can be used, for instance, to check that a system is operating reliably by performing background analysis when the system is off-line or in an idle/test mode. This may enable faults to be identified before they cause the system to crash or work ineffectively. Accordingly, the present invention may be used for in-car or in-flight fault recognition.

In a particular embodiment, the tool will repeat its measurements a number of times in order to provide statistical results.

In one embodiment, the tool will measure the time for each task to be performed.

The present invention may further comprise a means for selecting what occurrence is to be measured. This therefore provides for a flexible debug tool. The operation may be task jitter or task execution time, for one or more tasks. A number of repetitions for each measurement may also be selected to enable average results to be calculated.

### BRIEF DESCRIPTION OF THE DRAWINGS

Particular embodiments of the present invention will now be described with reference to the accompanying drawings, in which:

FIG. 1 illustrates an embodiment of the present invention for use with a commercial off-the-shelf (COTS) processor;

FIG. 2 illustrates an embodiment of the present invention for use with a custom System-on-Chip (SoC) processor;

FIG. 3 illustrates minimum and maximum task execution times obtained from a debugging tool according to an embodiment of the present invention; and

FIG. 4 illustrates average jitter times obtained from a debugging tool according to an embodiment of the present invention, when used with two different types of debug interface hardware.

### DETAILED DESCRIPTION OF CERTAIN EMBODIMENTS

The present invention provides a simple mechanism that can be used for the accurate collection of relevant debug information from TT embedded systems.

In an embodiment of the present invention, an Integrated Development Environment (IDE) 10 is employed on a general-purpose PC. In this embodiment, a standard (‘Eclipse’) IDE framework was used which was coupled to a C/C++ Development Tool (CDT). The IDE 10 was modified to include support for task detection and enhanced breakpoints. Accordingly, the modified IDE 10 constitutes a debugging tool according to an embodiment of the present invention.

In addition, a suitable piece of debug hardware 12 is employed, for example using the JTAG standard, to link the PC to the processor to be tested. In two particular test set-ups described below, a Wiggler™ and an ARM-USB-OCD device are used, respectively, as the debug hardware 12.

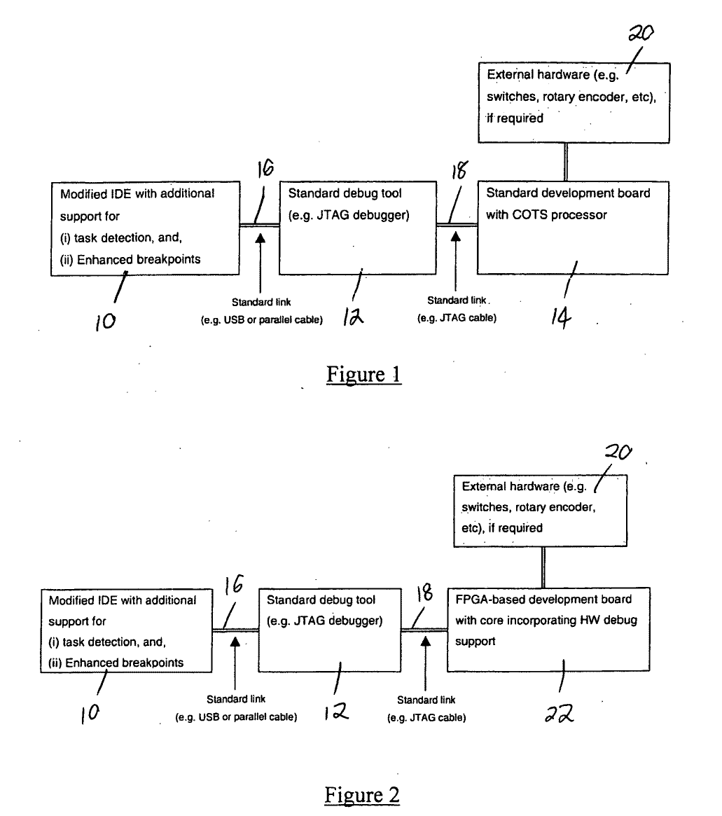

In one embodiment, a general-purpose (COTS) processor 14 configured to run 3 periodic tasks (A, B and C) is provided as the test processor. FIG. 1 illustrates the test set up in the case. Accordingly, the modified IDE 10, as described above, is linked through a standard USB or parallel cable 16 to a standard debug (hardware) tool (such as a JTAG debugger) 12 this itself is then linked through a standard JTAG cable 18 to the COTS processor 14. Optionally, external hardware (i.e. peripherals including switches or a rotary encoder) 20 may also be linked to the processor.

In an alternative embodiment, a SoC processor 22 that is also configured to run 3 periodic tasks (A, B and C) is provided as the test processor. FIG. 2 illustrates the test set up in this case. As above, the modified IDE 10, as described above, is linked through a standard USB or parallel cable 16 to a standard debug (hardware) tool (such as a JTAG debugger) 12 which itself is linked through a standard JTAG cable 18 to the processor 22. However, in this case, the processor 22 is provided in the form of a FPGA-based development board with a core incorporating hardware (HW) debug support. The hardware debug support includes hardware breakpoints and, optionally, a debug timer configured to be used for the debug timing measurements described below. As above, external hardware (i.e. peripherals including switches or a rotary encoder) 20 may be linked to the processor 22.

In an example of operation of the debugging tool according to an embodiment of the present invention, a user may choose to select ‘Check Task Jitter’ in the modified IDE 10. As such, the IDE 10 provides an interface between the user and the debugging tool of the present invention.

The tool then interrogates the system scheduler code on the processor 14, 22 to search for task details. In the above cases, the tool will identify the 3 periodic tasks (A, B and C).

When software breakpoints are employed, the tool will place a breakpoint at the start and end of each task, in order to measure all tasks in the same time cycle.

With hardware breakpoints, which are a limited resource, the tool will deal with tasks one at a time, using only one breakpoint. The breakpoint is initially set at the start of task, A. When hit (i.e. encountered), it will be removed and placed at the end of task A. When hit again, it will be moved back to the start of task A. This may be repeated 100 or 1000 times, as selected by a user through the IDE interface, before moving on to task B and then C, repeating the same procedure in each case.

Whenever a breakpoint is reached, timing information is gathered from the processor. The timing information in each of the above embodiments (FIGS. 1 and 2) is obtained from the scheduler timer, which provides time relative to a certain point. However, in other embodiments, a dedicated ‘debug’ timer provided on the processor may be used that provides the time between processor pauses. The timing information is obtained from the processor as either a “number of cycles” or as a “number of timer increments/decrements”. Translating this raw information to practical units (i.e. seconds) requires knowledge of the operating frequency (user input) and in certain cases, properties set during system initialization.

More specifically, when used with a COTS processor 14 (such as an ARM™ processor), the modified IDE 10 identifies the periodic events (i.e. tasks) provided in the system. These events may include all scheduled tasks and the timer update function. The user can choose all tasks or just a specific task, from a generated list, on which to perform the timing analysis. The tasks are provided with instructions to pause and resume the (peripheral) timer at the beginning and end of the task. When the debugging tool is executed, the IDE 10 goes through the list of selected tasks (alphabetically) and sets a breakpoint at the beginning of the task (say Task A) after the timer has been paused. The IDE 10 records the value of the timer (t1) at that point. The IDE 10 then deletes that breakpoint and sets it at the end of the task. The peripheral clock is then resumed and the processor 14 executes until it reaches the second breakpoint at the end of Task A. The IDE 10 again records the value of the timer (t2). The execution time for Task A is then obtained using formula (1) below:

(t2−t1)×time taken to increment the timer by one bit Formula (1)

To obtain the jitter for Task A, the IDE 10 waits until the breakpoint reaches the beginning of Task A again and the timer is recorded (t3). Task A jitter is then calculated using formula (2) below:

Task A period−(t3−t1) Formula (2)

The above operations are performed ‘x’ amount of times, as set by the user, to obtain average results. After completing the calculation for Task A, the IDE 10 resets the processor 14, and performs the calculation for the next task (if any). This technique is used due to the limited support for hardware breakpoints on COTS processors 14. For example, in the ARM™ processor only two hardware breakpoints are provided.

In accordance with aspects of the present invention, the breakpoints are inserted by the IDE 10 after the modified code is downloaded to the processor 14. Preferably, in the embodiments described, enhanced breakpoints are used to ensure that the clocks of all peripherals 20 are stopped along with the CPU 14.

It should be noted that—when enhanced software breakpoints are used—traditional debugging (with additional software breakpoints, inserted manually by the user) may still be carried out, without interfering with the task timing analysis performed in accordance with the present invention.

The results of the above measurements are displayed to the user. The results may be provided in the form of a bar graph, a table, or a distribution diagram.

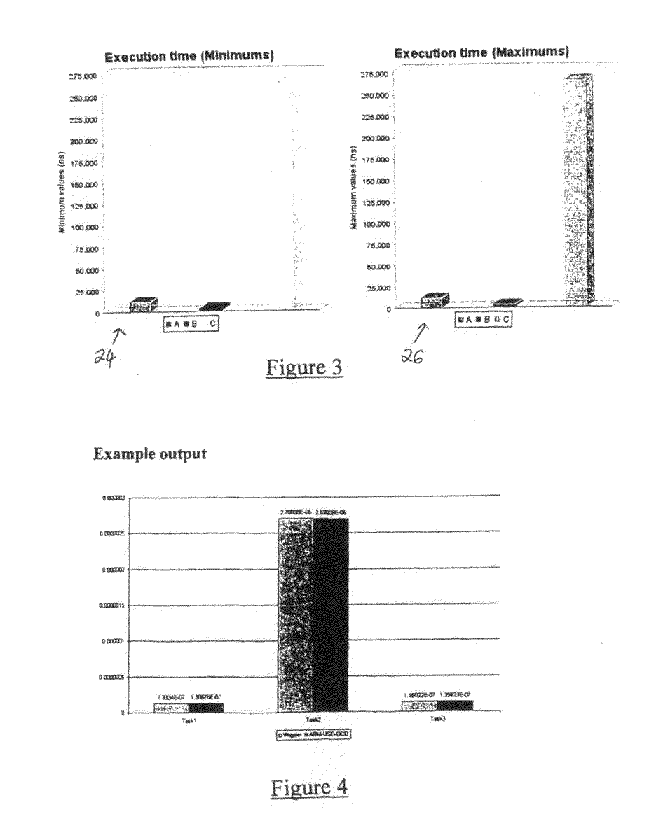

An example output from a debugging tool according to the present invention is illustrated in FIG. 3. The left-hand graph 24 displays the minimum execution time for each of three tasks while the right-hand graph 26 displays the maximum execution time for each task, taken from a large number of collected samples. The samples were collected from a general-purpose processor (a Philips LPC2294, ARM7 core on an Olimex development board) over a Parallel to JTAG cable (aka a Wiggler™). In this particular embodiment, task A was responsible for toggling an LED every second, task B flushed a buffer character-by-character to the desktop PC's serial link every forty milliseconds, and task C filled a buffer with the current time every second.

A further example output from a debugging tool according to the present invention is illustrated in FIG. 4. This shows a manually produced derivative from two runs of the tool and, in particular, shows the calculated jitter in seconds for each task, respectively, when a Wiggler™ was used and when an ARM-USB-OCD device was used as the debug interface hardware. From these results, it can be seen that the jitter in each set-up is broadly similar and so the results are largely independent of the debug hardware device used.

It is important to note that the above-described type of debug measurement is not permitted in traditional debugging tools since it is necessary to know about the nature and number of tasks in the system in order to carry out these measurements.

Other useful timing information may also (or alternatively) be measured in embodiments of the present invention, such as the jitter between A and C (i.e. the interval between the start or end of A and the start or end of C), the standard execution time for a task, and the worst-case execution time (WCET) for a task.

Thus, the present invention provides a widely applicable tool and technique for making jitter and WCET measurements in TT systems. This is particularly useful information to be able to obtain during system development so that these values can be taken into account in the system design to help ensure that the final product is highly reliable.

As described above, embodiments of the present invention may be configured for debugging COTS processors or custom systems.

In some general-purpose processors (i.e. the ARM processor), the debug interface will only stop the CPU when a breakpoint is encountered and will not stop all peripherals. In such cases, an enhanced breakpoint should be employed to stop the clocks on all peripherals as well as the CPU.

Also, in the case of a general-purpose processor, no dedicated timer is provided for use by the debugging tool and so the scheduler clock itself must be used. In order for the breakpoint itself not to affect the timing results in such a situation, the breakpoints are generally inserted as follows.
Pause_timer( )
BREAKPOINT
Resume_timer( )

Accordingly, the clock is paused before the breakpoint and resumed after the breakpoint. It is usually preferable to use macros for the above, rather than function calls, in order to keep the code as simple and therefore as fast as possible. However, the above situation is not ideal and the use of specialised hardware that propagates a CPU halt to all peripherals and has a dedicated ‘debug’ timer is preferable to minimise the amount of disturbance to normal system operation.

In addition to the above, the timer register on an ARM processor generally comprises only 32 bits. Thus, there may be timing situations where the debugging tool is required to take register overflow into consideration when analysing the timer results. Use of a dedicated ‘debug’ timer that comprises 64 bits is much less likely to suffer a register overflow and so the analysis of the timer results can be made easier.

Overall, a debugging tool according to the present invention allows effective and very rapid monitoring of a time-triggered system during development thereby helping to ensure that the final system operates with predictable behaviour, as required.

It will be appreciated by persons skilled in the art that various modifications may be made to the above-described embodiments without departing from the scope of the present invention. For example, whilst the above discussion has been primarily concerned with a debugging tool for use in the development of embedded systems, the invention is equally applicable to other applications where it may be useful to monitor or test the operation of a system, for example when the system is off-line.

1. A debugging tool for a time-triggered system comprising:
means for interrogating the system code to determine task details;
means for modifying the system code to include breakpoints, the position of the breakpoints being determined by the task details;
means for executing the modified system code;
means for measuring the time between pre-determined ones of said breakpoints; and
means for reporting the timing results to a user.

2. The debugging tool according to claim 1 wherein the breakpoints are configured to cause a CPU and at least one peripheral to pause.

3. The debugging tool according to claim 1 wherein the breakpoints are provided in hardware.

4. The debugging tool according to claim 1 wherein the timing results are capable of triggering a system shut down or initiating a system-recovery procedure when they exceed a pre-determined threshold.

5. The debugging tool according to claim 1 configured for use in debugging a traditional general-purpose processor running time-triggered software, a dedicated time-triggered processor, a system-on-chip or a system simulator.

6. The debugging tool according to claim 1 configured such that when a breakpoint is encountered, a system co-processor is triggered to signal external debug circuitry to broadcast a pause request to an instruction processing unit (IPU) and to at least one peripheral.

7. The debugging tool according to claim 1 wherein the means for measuring the time between pre-determined ones of the breakpoints comprises a mechanism for using a timer provided for a task scheduler.

8. The debugging tool according to claim 1 wherein the means for measuring the time between pre-determined ones of the breakpoints comprises a dedicated timer with a pre-determined overrun time to permit the intended measurement periods.

9. The debugging tool according to claim 1 wherein means for measuring the time between pre-determined ones of the breakpoints is configured to note a first value of a timer when a first breakpoint is encountered, to resume the timer and note its second value when a subsequent breakpoint is encountered, and to calculate the elapsed time between the first and second values.

10. The debugging tool according to claim 1 wherein the task details comprise one or more of the task name or identifier, the location of each task in memory., or the number of tasks.

11. The debugging tool according to claim 1 wherein breakpoints are inserted at the start of a task and at the end of the task so as to enable measurement of the task execution time.

12. The debugging tool according to claim 1 wherein breakpoints are inserted at the start of a periodic task so as to enable measurement of the interval between successive start times.

13. The debugging tool according to claim 1 provided in a discrete hardware module.

14. The debugging tool according to claim 1 configured for in-use fault recognition.

15. The debugging tool according to claim 1 configured to repeat its measurements a number of times in order to provide statistical results.

16. The debugging tool according to claim 1 configured to measure the time taken for each task to be performed.

17. The debugging tool according to claim 1 further comprising a means for selecting an event to be measured.

18. The debugging tool according to claim 1 configured to measure task jitter for one or more tasks.

19. A method of debugging a time-triggered scheduler comprising the following steps:
interrogating the system code to determine task details;
modifying the system code to include breakpoints, the position of the breakpoints being determined by the task details;
executing the modified system code;
measuring the time between pre-determined ones of said breakpoints; and
reporting the timing results to a user.

20-21. (canceled)
